(19) United States
(12) Patent Application Publication
(10) Pub. No.: US 2022/0224017 A1
(43) Pub. Date: Jul. 14, 2022

(54) CAPACITIVE-COUPLED COMB-LINE MICROSTRIP ARRAY ANTENNA AND METHOD OF MANUFACTURING THE SAME

(71) Applicant: Electronics and Telecommunications Research Institute, Daejeon (KR)

(72) Inventor: Jae Ho LEE, Suwon-si (KR)

(73) Assignee: Electronics and Telecommunications Research Institute, Daejeon (KR)

(21) Appl. No.: 17/570,907

(22) Filed: Jan. 7, 2022

(30) Foreign Application Priority Data
Jan. 8, 2021 (KR) 10-2021-0002717

(51) Int. Cl. H01Q 21/00; H01Q 9/04; H01Q 21/06

(52) U.S. Cl. CPC H01Q 21/0025; H01Q 21/065; H01Q 9/0457

(57) ABSTRACT

Disclosed is a capacitive-coupled comb-line microstrip array antenna including a dielectric substrate, first and second feeding lines formed on one surface of the dielectric substrate and in parallel branched from a feeding line connected to an input port, and microstrip patches intersected and arranged in a way to be partially overlapped within an area where the parallel first and second feeding lines are formed to face each other. The microstrip patches include a first group of microstrip patches formed in a direction orthogonal to the first feeding line with a gap between the microstrip patches and the first feeding line and a second group of microstrip patches formed in a direction orthogonal to the second feeding line with a gap between the microstrip patches and the second feeding line.

### CROSS-REFERENCE TO RELATED APPLICATIONS

This application claims the benefit of Korean Patent Application No. 10-2021-0002717, filed on Jan. 8, 2021, the disclosure of which is incorporated herein by reference in its entirety.

### BACKGROUND

### 1. Technical Field

The present disclosure relates to a microstrip array antenna (a.k.a., a microstrip patch array antenna), and particularly, to a comb-line microstrip array antenna in which rectangular microstrip patches are alternatively arranged on either side of the straight feeding line and used as radiating elements.

### 2. Related Art

A microstrip array antenna or a microstrip patch array antenna can be easily attached to a non-planar surface as well as a low-profile planar surface, can be simply designed and can be manufactured at low price by using a printed circuit technology. Furthermore, the microstrip array antenna or the microstrip patch array antenna can be designed along with a monolithic microwave integrated circuit, and is applied to various fields due to its excellent mechanical strength.

A common microstrip patch array antenna has a shape, such as a rectangle, a square, a circle, or a ring shape (ring) and is mainly used in a form in which patches are arranged in order to increase an antenna gain or control a radiation pattern, but is also used as a single radiating element. A series-fed or corporate-fed method is chiefly used as a feed method for the microstrip patch array antenna. Each of the series-fed and corporate-fed methods has advantages and disadvantages. In the most common form of the microstrip patch array antenna using the series-fed method, patches, that is, multiple radiating elements, are linearly disposed. The radiating elements are connected by a microstrip line to form an array.

As a common example of the microstrip patch array antenna, FIG. 1 illustrates a comb-line microstrip patch array antenna including a radiating element array 13 including a microstrip feeding line 11 elongated on one surface of a dielectric substrate 10 and microstrip patches 12 arranged on one side or both sides of the microstrip feeding line 11 and electrically connected to the feeding line 11. A ground plane 14 is formed on the other surface of the dielectric substrate 10. In the antenna having such a form, the microstrip feeding line 11 and the microstrip patches 12, that is, radiating elements, are electrically connected. Radiation conductance of the radiating elements is controlled by adjusting the widths of the microstrip patches 12 (From FIG. 1, it may be seen that the widths of the microstrip patches 12 are different from one another).

However, in such an antenna having a linear array structure, in order to design an array antenna including a radiation pattern having a low side lobe level, edge radiating elements disposed on the input stage side and end side of an antenna feeding unit need to have radiation conductance having a low value, and radiating elements disposed toward the center of the antenna feeding unit need to have radiation conductance having a relatively high value. Accordingly, the width of the microstrip patch in the middle of the antenna array is wide, but the width of the microstrip patch disposed on an edge thereof is narrowed. If the width of the microstrip patch is wide as described above, radiation conductance can be divided into polarization components in the length direction and width direction of the microstrip patch because a current on the microstrip patch has a component in the width direction of the microstrip patch as well as a component in the length direction thereof. Accordingly, it is difficult to design radiation conductance having a desired weighting distribution of voltages or power, and a cross polarization component is increased due to a microstrip patch having a wide width. Furthermore, a phase of a microstrip patch having a wide width needs to be adjusted by adjusting a location of a radiating element because an effective radiating point is changed in the microstrip patches. Accordingly, in such a conventional comb-line microstrip patch array antenna, lowering the side lobe level is limited and the difficulty of design is also increased.

### SUMMARY

Various embodiments propose an improved comb-line microstrip array antenna capable of solving cross polarization and a difficulty in the design of a low side lobe level, which occur in the aforementioned conventional comb-line microstrip patch array antenna, by easily adjusting radiation conductance of a radiating element in an improved way, and a method of manufacturing the same.

Furthermore, various embodiments propose an improved comb-line microstrip array antenna having a wide beam width on a horizontal plane (i.e., E-plane) in line with the trend that requires recent wireless communication in a millimeter band or wide communication required for a radar for a vehicle, etc. and search area coverage and that requires an antenna having characteristics, such as a high gain, a wide azimuth beam width and a wide bandwidth for the wide communication and search area coverage, and a method of manufacturing the same.

In order to solve the objects, the present disclosure provides a capacitive-coupled comb-line microstrip array antenna in which a feeding line and microstrip patches have a gap (or interval) therebetween and the microstrip patches, that is, radiating elements, resonate by power supplied through electromagnetic capacitive (dielectric) coupling and which solves the disadvantages of the conventional comb-line microstrip array antenna, that is, cross polarization and a difficulty in the design of a low side lobe level and has wide radiation pattern and wide bandwidth characteristics, a high gain, and a wide beam width on a horizontal plane (i.e., E-plane) by adjusting radiation conductance of a radiating element through the adjustment of the gap.

Specifically, a capacitive-coupled comb-line microstrip antenna according to an embodiment of the present disclosure may include: a dielectric substrate; a feeding line formed on the dielectric substrate in a length direction thereof; and microstrip patches formed in a direction orthogonal to the feeding line at given interval from the feeding line between the microstrip patch and the feeding line.

Furthermore, a capacitive-coupled comb-line microstrip array antenna according to another embodiment of the present disclosure may include: a dielectric substrate; a feeding line formed on the dielectric substrate in a length direction thereof; a radiating element array module having microstrip patches formed in a direction orthogonal to the feeding line with a gap G between the microstrip patch and the feeding line and arranged at given intervals on one side of the feeding line; and a ground plane formed on the bottom surface of the dielectric substrate.

In the embodiments, the gap G between the feeding line and the microstrip patch may be determined by the length of the microstrip patch having a resonant state.

It is preferred that the microstrip patch has a rectangular shape and the same width.

The microstrip patches formed in the radiating element array module are formed at intervals each corresponding to a wavelength λ_{g} of the feeding line.

Furthermore, a capacitive-coupled comb-line microstrip array antenna according to still another embodiment of the present disclosure may further include a radiating element array module having microstrip patches vertically formed with a given gap between the microstrip patch and the feeding line and arranged at given intervals on the other side of the feeding line.

The microstrip patches formed in the radiating element array module formed on the one side of the feeding line and the microstrip patches formed in the radiating element array module formed on the other side thereof each is formed to have an open stub with the feeding line interposed therebetween.

The microstrip patches formed in the radiating element array module are formed at intervals corresponding to half of a wavelength (λ_{g}/2) of the feeding line.

The resonant length of the microstrip patch is determined on the basis of the gap G between the feeding line and the microstrip patch.

The radiating element array module may be formed in plural in parallel.

The gap G between the feeding line and the microstrip patch may be formed to correspond to the desired amplitude or power weighting distribution.

Furthermore, a direction of a beam may be adjusted by adjusting an excited phase in the microstrip patch, that is, a radiating element.

A capacitive-coupled comb-line microstrip array antenna according to yet another embodiment of the present disclosure may include: a dielectric substrate; first and second feeding lines formed on one surface of a dielectric substrate and in parallel branched from a feeding line connected to an input port; and microstrip patches intersected and arranged in a way to be partially overlapped within an area where the parallel first and second feeding lines are formed to face each other. In this case, the microstrip patches include a first group of microstrip patches formed in a direction orthogonal to the first feeding line with a gap between the microstrip patches and the first feeding line and a second group of microstrip patches formed in a direction orthogonal to the second feeding line with a gap between the microstrip patches and the second feeding line.

A method of manufacturing a capacitive-coupled comb-line microstrip array antenna according to still yet another embodiment of the present disclosure may include: forming, on one surface of a dielectric substrate, first and second feeding lines in parallel branched from a feeding line connected to an input port; and forming microstrip patches intersected and arranged in a way to be partially overlapped within an area where the parallel first and second feeding lines are formed to face each other. The forming of the microstrip patches may include forming a first group of microstrip patches in a direction orthogonal to the first feeding line with a gap between the microstrip patches and the first feeding line, and forming a second group of microstrip patches in a direction orthogonal to the second feeding line with a gap between the microstrip patches and the second feeding line.

A configuration and operation of the present disclosure will become more evident through detailed embodiments subsequently described with reference to the drawings.

### BRIEF DESCRIPTION OF THE DRAWINGS

FIG. 1 is a concept view of a conventional comb-line microstrip array antenna.

FIG. 2 is a diagram illustrating one microstrip patch for describing the principle of a capacitive-coupled comb-line microstrip array antenna according to an embodiment of the present disclosure.

FIG. 3 is an equivalent circuit diagram of FIG. 2.

FIG. 4 is a configuration diagram of a capacitive-coupled comb-line microstrip array antenna in which capacitive-coupled microstrip patches of FIG. 2 are arranged on one side of a feeding line.

FIG. 5 is a configuration diagram of a capacitive-coupled comb-line microstrip array antenna in which the capacitive-coupled microstrip patches of FIG. 2 are arranged on both sides of the feeding line in a form different from that of FIG. 4.

FIG. 6 illustrates an equivalent circuit of the capacitive-coupled comb-line microstrip array antenna according to the embodiment of FIG. 5.

FIG. 7 illustrates an equivalent circuit in a resonant state in which only a conductance component, that is, a real part of the admittance for a microstrip patch, remains in the equivalent circuit of FIG. 6.

FIG. 8 illustrates a capacitive-coupled comb-line microstrip patch array antenna having a 1×18 radiating element structure in the case of the embodiment of FIG. 5.

FIG. 9 illustrates a capacitive-coupled comb-line microstrip patch array antenna having a 4×18 radiating element structure in the case of the embodiment of FIG. 5.

FIG. 10 is a graph illustrating reflection coefficients of the 1×18 capacitive-coupled comb-line microstrip patch array antenna.

FIG. 11 is a graph illustrating reflection coefficients of the 4×18 capacitive-coupled comb-line microstrip patch array antenna.

FIG. 12 is a graph illustrating simulated values and measured values of a radiation pattern for a vertical plane (i.e., y-z plane) of the 1×18 capacitive-coupled comb-line microstrip patch array antenna in the 79 GHz frequency band.

FIG. 13 is a graph illustrating simulated values and measured values of a radiation pattern for a horizontal plane (i.e., x-z plane) of the 1×18 capacitive-coupled comb-line microstrip patch array antenna in the 79 GHz frequency band.

FIG. 14 is a graph illustrating simulated values and measured values of the radiation pattern for the vertical plane (i.e., y-z plane) of the 4×18 capacitive-coupled comb-line microstrip patch array antenna in a 79 GHz frequency band.

FIG. 15 is a graph illustrating simulated values and measured values of the radiation pattern for the horizontal plane (i.e., x-z plane) of the 4×18 capacitive-coupled comb-line microstrip patch array antenna in a 79 GHz frequency band.

FIG. 16 is a configuration diagram of a capacitive-coupled comb-line microstrip array antenna according to an embodiment modified from the embodiment of FIG. 5.

FIG. 17 is a graph illustrating measured reflection coefficients of the capacitive-coupled comb-line microstrip array antenna according to the embodiment of FIG. 16.

FIG. 18 illustrates a radiation pattern (79 GHz) in a vertical plane (i.e., H-plane) of the capacitive-coupled comb-line microstrip array antenna according to the embodiment of FIG. 16.

FIG. 19 illustrates a radiation pattern (79 GHz) in a horizontal plane (i.e., E-plane) of the capacitive-coupled comb-line microstrip array antenna according to the embodiment of FIG. 16.

### DETAILED DESCRIPTION

Advantages and characteristics of the present disclosure and a method for achieving the advantages and characteristics will become apparent from preferred embodiments described in detail in conjunction with the accompanying drawings. However, the present disclosure is not limited to the embodiments described hereinafter, but may be implemented in various different forms. The embodiments are provided to only fully disclose the present disclosure and to fully notify a person having ordinary knowledge in the art to which the present disclosure pertains of the category of the present disclosure. The present disclosure is defined by the writing of the claims. Furthermore, terms used in the specification are used to describe the embodiments and are not intended to limit the present disclosure. In this specification, an expression of the singular number includes an expression of the plural number unless specially defined otherwise in the context. Furthermore, terms “comprise” and/or “comprising” used in the specification are used as a meaning not excluding the existence or addition of one or more other elements, steps, operations and/or devices in addition to a mentioned element, step, operation and/or device. Hereinafter, preferred embodiments of the present disclosure are described in detail with reference to the accompanying drawings. In describing the embodiments, when it is determined that a detailed description of a related known configuration or function may obscure the subject matter of the present disclosure, the detailed description will be omitted.

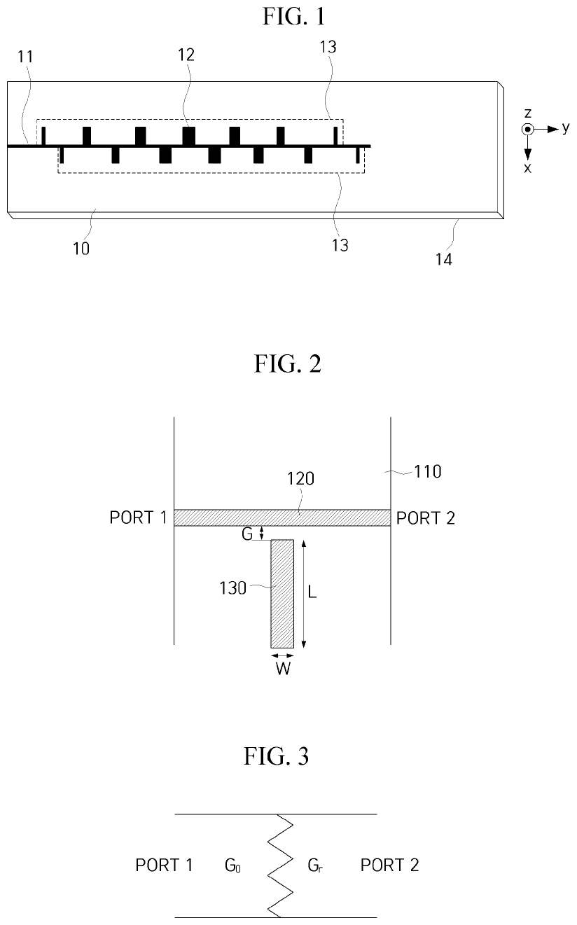

FIG. 2 is a diagram illustrating one capacitive-coupled microstrip patch antenna in order to describe the principle of a capacitive-coupled comb-line microstrip array antenna according to an embodiment of the present disclosure. FIG. 2 illustrates one capacitive-coupled microstrip patch. A capacitive-coupled comb-line microstrip patch array antenna according to an embodiment of the present disclosure may be configured by arranging the microstrip patch of FIG. 2 in plural. Furthermore, FIG. 3 is an equivalent circuit diagram of the unit capacitive-coupled comb-line microstrip patch antenna illustrated in FIG. 2.

As illustrated in FIG. 2, the capacitive-coupled comb-line microstrip antenna according to an embodiment of the present disclosure includes a dielectric substrate 110, a feeding line 120, and a radiating element 130.

The dielectric substrate 110 is formed in a planar form having a given dielectric constant (εᵣ). Furthermore, the feeding line 120 is elongated on one surface of the dielectric substrate 110. A radiating element, that is, the microstrip patch 130, is formed (capacitive coupling) on one side of the feeding line 120 in a length direction thereof with a given gap G between the microstrip patch 130 and the feeding line 120 in a way to be orthogonal to the feeding line. That is, the microstrip patch 130 is not electrically connected to the feeding line 120 and is disposed with the gap (or interval) interposed therebetween, so that the microstrip patch 130 resonates by being electromagnetically excited through capacitive coupling from the feeding line 120. In this case, a desired antenna beam may be designed by adjusting radiation conductance of the microstrip patch 130, that is, a radiating element, through the gap between the microstrip patch 130 and the feeding line 120.

In the present disclosure, radiation conductance Gᵣ of the radiating element 130 is calculated from the radiating element 130 having a resonant state on the basis of the gap G between the feeding line 120 and the radiating element 130. That is, in the equivalent circuit illustrated in FIG. 3, radiation conductance Gᵣ of the capacitive-coupled microstrip antenna according to an embodiment of the present disclosure may be calculated from an S-parameter in FIG. 2 by using the following relation equation.

$$\frac{{G}_{r}}{{G}_{0}} = \frac{2 ( 1 - {S}_{21} )}{{S}_{21}}$$

In the equation, Gᵣ is the radiation conductance, G₀ is characteristic impedance of the feeding line, and S₂₁ is power delivered from an input Port 1 to an output Port 2. Radiation conductance according to the gap G between the feeding line and the microstrip patch may be calculated from the equation. A comb-line microstrip patch array antenna may be designed by disposing each radiating element 130 in a way to have conductance required to synthesize antenna beam patterns desired to be designed.

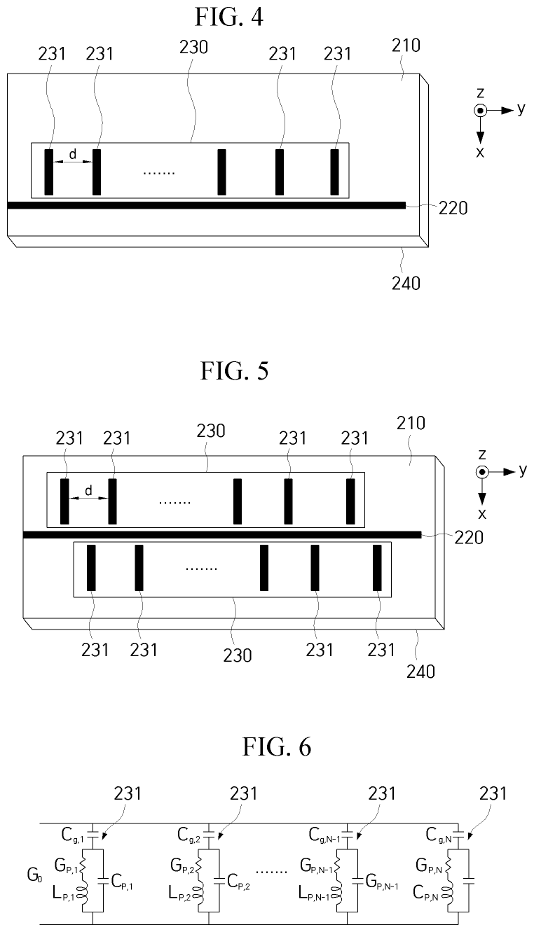

FIG. 4 illustrates a capacitive-coupled comb-line microstrip array antenna in which the single capacitive-coupled microstrip patches of FIG. 2 are arranged. As illustrated in FIG. 4, the capacitive-coupled comb-line microstrip array antenna of the present disclosure includes a dielectric substrate 210, a feeding line (or microstrip feeding line) 220, a radiating element array module 230 and a ground plane 240.

The ground plane 240 may be formed on the bottom surface of the dielectric substrate 210, that is, a surface opposite to a surface on which the feeding line 220 and the radiating element array module 230 are formed.

The dielectric substrate 210 and the feeding line 220 are the same as those illustrated in FIG. 2.

The radiating element array module 230 is formed by arranging, on one side of the feeding line 220, microstrip patches 231 formed in a direction orthogonal to the feeding line 220 with a given distance d therebetween with a gap between the microstrip patches 231 and the feeding line 220. In this case, the microstrip patches 231 are not directly connected to the feeding line 220 and are disposed with the gap therebetween. The microstrip patches 231 electromagnetically resonate through capacitive coupling along with the feeding line 220. It is preferred that the microstrip patches have a rectangular shape and identical width. A capacitive-coupled comb-line array antenna having desired performance may be designed by forming a gap between the microstrip patches 231 and the feeding line 220 in a way to correspond to radiation conductance Gᵣ desired to be obtained.

Furthermore, it is preferred that the distance d between the microstrip patches 231 formed in the radiating element array module 230 is formed to correspond to a wavelength λ_{g} of the feeding line 220 in order to form a beam to the front of the capacitive-coupled comb-line microstrip array antenna. Furthermore, it is preferred that the microstrip patch 231 is formed to have a length in the resonant state on the basis of the length of the gap G.

The capacitive-coupled comb-line microstrip array antenna of the present disclosure may be designed to form a desired beam by adjusting radiation conductance of the microstrip patches 231, that is, radiating elements, based on the gap between the microstrip patches 231 and the feeding line 220. Furthermore, unlike a conventional comb-line antenna in which the feeding line 220 and the microstrip patches 231, that is, radiating elements, are electrically connected, the capacitive-coupled comb-line microstrip array antenna uses, as can be seen from its name, a method of supplying power to the microstrip patches 231 through a capacitive coupling mechanism.

FIG. 5 illustrates a capacitive-coupled comb-line microstrip array antenna in which the capacitive-coupled microstrip patches of FIG. 2 are arranged in a form different from that of FIG. 4.

The capacitive-coupled comb-line microstrip array antenna according to the embodiment illustrated in FIG. 5 includes radiating element array modules 230 in which two groups of microstrip patches 231 each arranged at given intervals and formed in a direction orthogonal to a feeding line 220 on both sides of the feeding line 220 face each other.

In this case, it is preferred that a distance d between the radiating elements 231 included in a first radiating element array module 230 formed on one side of the feeding line 220 and a second radiating element array module 230 formed on the other side of the feeding line 220 is formed to have an open stub. Furthermore, it is preferred that the distance between the radiating elements 231 formed in the radiating element array module 230 is formed to have an interval corresponding to half of a wavelength (λ_{g}/2) of the feeding line 220.

In the embodiment of FIG. 5, a direction of a beam may be adjusted by adjusting a phase excited in each microstrip patch 231, that is, a radiating element. That is, when it is necessary for capacitive-coupled comb-line microstrip array antenna to form a beam in a desired direction, a phase excited in each microstrip patch 231, that is, a radiating element, needs to be adjusted. Accordingly, a direction of a beam may also be adjusted by adjusting the distance between the microstrip patches.

As described above, in the case of the capacitive-coupled comb-line microstrip array antenna according to the embodiment of FIG. 5, in order to supply power to the capacitive-coupled comb-line microstrip array antenna, a part of the feeding line 220, that is, an input part of the capacitive-coupled comb-line microstrip array antenna, may be directly connected to a chip or a transmission line or may be changed into transition parts having various forms. Furthermore, a matching circuit, such as a quarter wavelength (λ/4) transformer, may be added for impedance matching, if necessary.

The feeding line 220 may be configured in a microstrip line form, and may be configured by changing the width of a microstrip line thereof in a way to achieve various pieces of characteristic impedance G₀ for the ease of the design and fabrication depending on dielectric constant εᵣ of the dielectric substrate 210.

Furthermore, in order for the microstrip patches 231, that is, radiating elements, to be supplied with power in phase, an interval between the open stubs is disposed to correspond to half of the wavelength (λ_{g}/2) of the microstrip feeding line 220 on both sides of the feeding line 220.

In the embodiment of FIG. 5, before an antenna having the same performance as a conventional comb-line microstrip patch array antenna is designed, the distance d between the arranged microstrip patches 231 is determined, and then a length of the microstrip patch 231 having a resonant state is detected on the basis of the gap G.

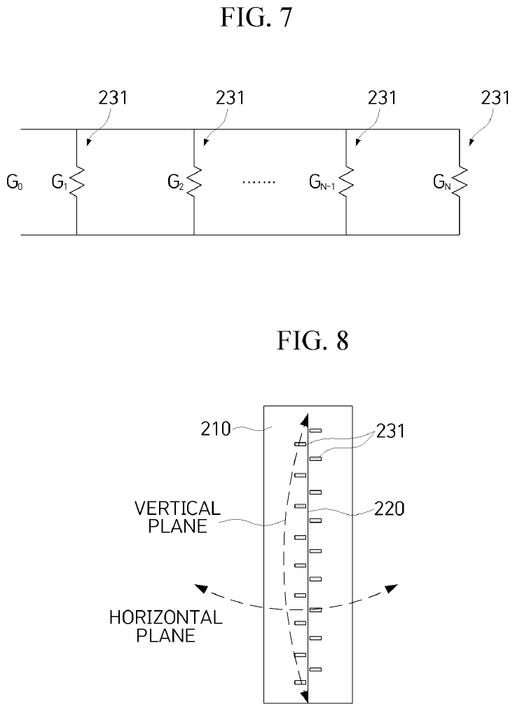

FIG. 6 illustrates an equivalent circuit of the capacitive-coupled comb-line microstrip array antenna according to the embodiment of FIG. 5. FIG. 7 is an equivalent circuit when a state of the capacitive-coupled comb-line microstrip array antenna according to the embodiment of FIG. 5 becomes a resonant state in which a susceptance component, that is, an imaginary part of admittance, is cancelled out and only a conductance component, that is, a real part of the admittance thereof, remains by adjusting the length of the microstrip patch 231.

In FIG. 6, in the capacitive-coupled comb-line microstrip array antenna according to the embodiment of FIG. 5, admittance of each microstrip patch 231 may be represented by parasitic capacitance Cg according to the gap G between the microstrip feeding line 220 and the microstrip patches 231, conductance and parasitic inductance Lp by the microstrip patch 231, parasitic capacitance Cp with a ground plane, and conductance Gp.

In this case, a state of the capacitive-coupled comb-line microstrip array antenna becomes the resonant state in which a susceptance component, that is, an imaginary part of admittance, is offset and only a conductance component, that is, a real part thereof, remains by adjusting the length of the microstrip patch 231. In this case, an equivalent circuit of the capacitive-coupled comb-line microstrip array antenna may be illustrated as in FIG. 7.

Accordingly, in the present embodiment, the length (L in FIG. 2) of the microstrip patch 231 according to the gap G is determined as in [Table 1] by detecting the length of the microstrip patch 231 in which the resonant state occurs on the basis of the gap G while the length of the gap G is adjusted.

TABLE 1

| Element Number [symbol] | Gap (Gᵢ) [symbol] | Length (Lₜ) [symbol] |
|---|---|---|
| (i = 1-18) [symbol] | [mm] [symbol] | [mm] [symbol] |
| 1, 18 [symbol] | 0.155 [symbol] | 1.025 [symbol] |
| 2, 17 [symbol] | 0.155 [symbol] | 1.025 [symbol] |
| 3, 16 [symbol] | 0.151 [symbol] | 1.024 [symbol] |
| 4, 15 [symbol] | 0.142 [symbol] | 1.024 [symbol] |
| 5, 14 [symbol] | 0.128 [symbol] | 1.022 [symbol] |
| 6, 13 [symbol] | 0.116 [symbol] | 1.021 [symbol] |
| 7, 12 [symbol] | 0.107 [symbol] | 1.019 [symbol] |
| 8, 11 [symbol] | 0.102 [symbol] | 1.018 [symbol] |
| 9, 10 [symbol] | 0.100 [symbol] | 1.018 [symbol] |

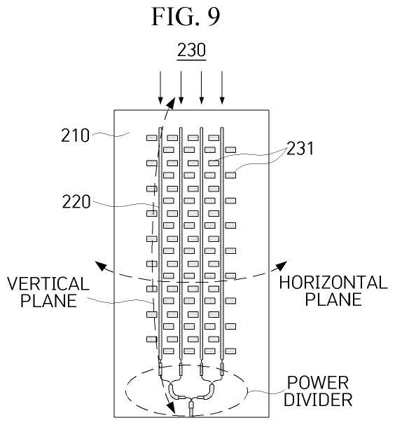

FIG. 8 illustrates a 1×18 capacitive-coupled comb-line microstrip patch array antenna in which eighteen radiating elements 231 are arranged in a pair of radiating element array modules 230 in the capacitive-coupled comb-line microstrip array antenna according to the embodiment of FIG. 5. FIG. 9 illustrates a 4×18 capacitive-coupled comb-line microstrip patch array antenna in which four pairs of radiating element array modules 230 each including eighteen radiating elements 231 are combined in parallel.

The 1×18 capacitive-coupled comb-line microstrip patch array antenna and the 4×18 capacitive-coupled comb-line microstrip patch array antenna are designed to operate in a 79 GHz band. Radiation conductance of each microstrip patch 231 is designed to have a power weighting distribution so that a side lobe level of a vertical beam becomes a −20 dB Taylor distribution in an array direction of the antenna.

The distance between the radiating elements is half of a wavelength (λ_{g}/2) of the feeding line 220. An interval between the radiating elements and the feeding line 220 is different depending on the power weighting distribution.

The Taylor distribution is designed to have an increasing gap G between the radiating elements and the feeding line 220 because a radiation conductance value is high in the middle portion of the array and becomes lower toward both sides of the array.

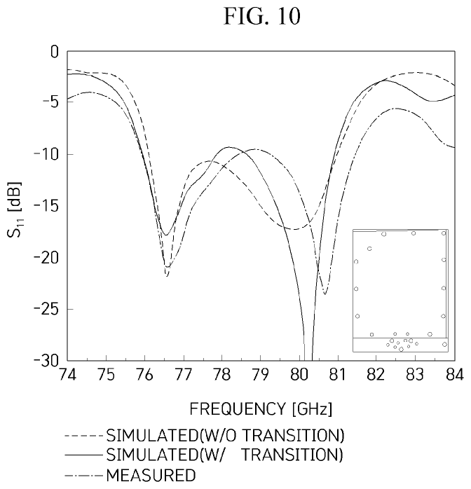

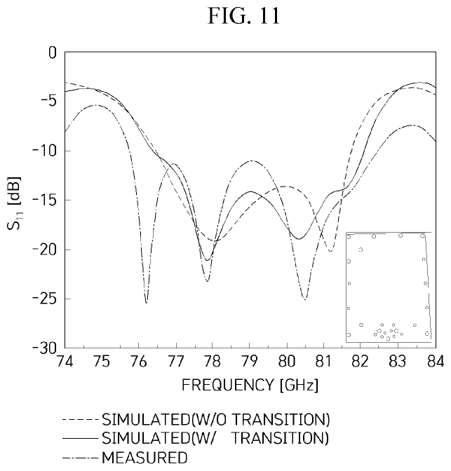

FIG. 10 is a graph illustrating reflection coefficients of the 1×18 capacitive-coupled comb-line microstrip patch array antenna. FIG. 11 is a graph illustrating reflection coefficients of the 4×18 capacitive-coupled comb-line microstrip patch array antenna. From FIGS. 10 and 11, it may be seen that simulated values and measured values of the reflection coefficients of the capacitive-coupled comb-line microstrip patch array antennas according to the present disclosure are similar.

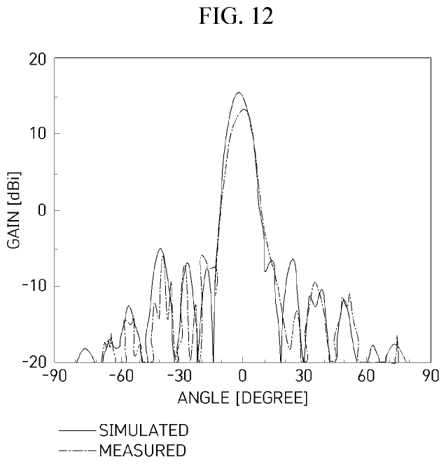

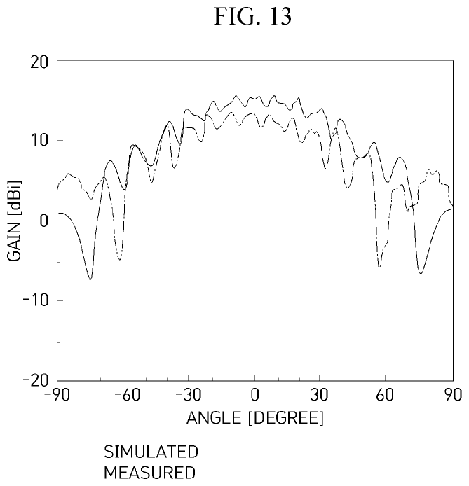

FIG. 12 illustrates simulated values and measured values of a radiation pattern of the 1×18 capacitive-coupled comb-line microstrip patch array antenna, and is a graph illustrating the simulated values and measured values of the radiation pattern for a vertical plane (i.e., y-z plane) in the 79 GHz frequency band. FIG. 13 illustrates simulated values and measured values of a radiation pattern of the 1×18 capacitive-coupled comb-line microstrip patch array antenna, and is a graph illustrating simulated values and measured values of the radiation pattern for a horizontal plane (i.e., x-z plane) in the 79 GHz frequency band.

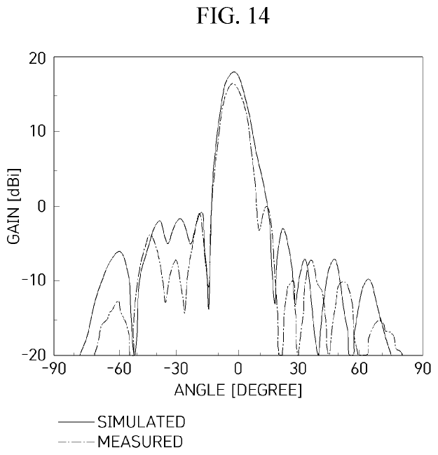

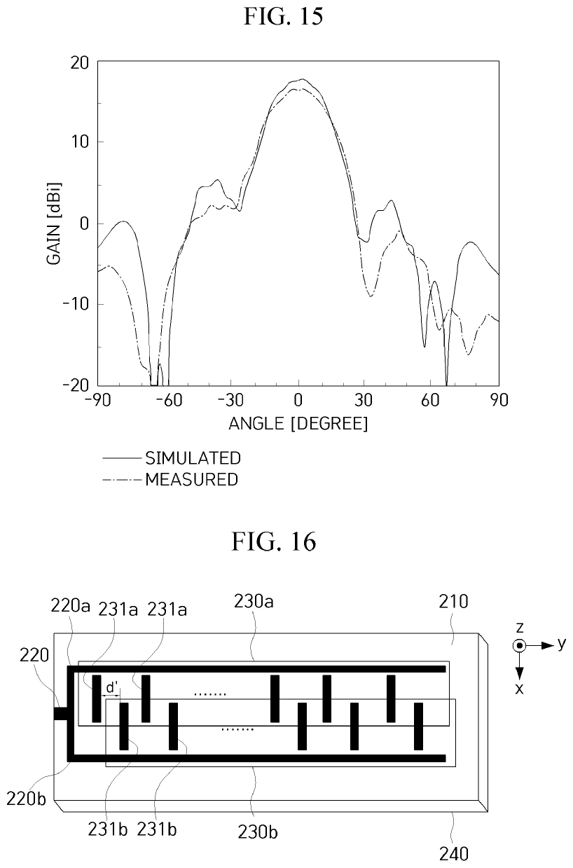

FIG. 14 illustrates simulated values and measured values of a radiation pattern of the 4×18 capacitive-coupled comb-line microstrip patch array antenna, and is a graph illustrating the simulated values and measured values of the radiation pattern for the vertical plane (i.e., y-z plane) in the 79 GHz frequency band. FIG. 15 illustrates simulated values and measured values of a radiation pattern of the 4×18 capacitive-coupled comb-line microstrip patch array antenna, and is a graph illustrating the simulated values and measured values of the radiation pattern for the horizontal plane (i.e., x-z plane) in the 79 GHz frequency band.

It can be seen that both the 1×18 capacitive-coupled comb-line microstrip patch array antenna and the 4×18 capacitive-coupled comb-line microstrip patch array antenna have a side lobe level of −20 dB or less in the vertical plane (i.e., y-z plane), so an antenna beam is directed toward the front of the antenna in the 79 GHz frequency band.

In the present embodiment, the capacitive-coupled comb-line microstrip patch array antenna for the 79 GHz frequency band is described as an example, but the same performance can be achieved even in 78 GHz and 80 GHz frequency bands.

FIG. 16 is a configuration diagram of a capacitive-coupled comb-line microstrip array antenna according to an embodiment modified from the embodiment of FIG. 5. In FIG. 16, the capacitive-coupled comb-line microstrip array antenna according to the embodiment illustrated in FIG. 5 has been designed to have a wider beam width in the E-plane (i.e., x-z plane).

A ground plane 240 is formed on the bottom surface of a dielectric substrate 210. Two microstrip feeding lines 220a and 220b in parallel branched from a feeding line 220 connected to an input port of the capacitive-coupled comb-line microstrip array antenna through a T-junction are formed on the top surface of the dielectric substrate 210. Furthermore, two radiating element array modules, that is, a first radiating element array module 230a and a second radiating element array module 230b, are disposed within an area where the parallel feeding lines 220a and 220b are formed to face each other. Microstrip patches 231a and 231b electromagnetically connected to the feeding lines 220a and 220b through capacitive coupling with a gap therebetween, without being electrically connected to the feeding lines 220a and 220b, are arranged in the radiating element array modules 230a and 230b, respectively. Furthermore, the microstrip patches 231a and 231b arranged within the first radiating element array module 230a and the second radiating element array module 230b, respectively, are partially overlapped and intersected.

As described above, the microstrip patches 231a and 231b are intersected and arranged in a way to be partially overlapped in the area between the parallel feeding lines 220a and 220b. Accordingly, a beam width in the E-plane (i.e., x-z plane) is further widened compared to the capacitive-coupled antenna according to the embodiment of FIG. 5 because a size of the radiating element module in an x-axis direction can be reduced compared to the embodiment of FIG. 5. Accordingly, it is possible to implement an antenna having characteristics, such as a high gain, a wider radiation pattern and a wide bandwidth, required to meet recent wireless communication in a millimeter band or wide communication required for a radar for a vehicle, etc. and search area coverage.

More specifically, an array of the microstrip patches 231a and 231b disposed to have the gap between the microstrip patches 231a and 231b and the feeding line 220 without being electrically connected to the feeding line 220 (capacitive coupling) is configured in the form of the T-junction from the two parallel microstrip feeding lines 220a and 220b to only one side (within the area where the two parallel microstrip feeding lines 220a and 220b face each other). The array is connected to the input port (not illustrated) of the capacitive-coupled comb-line microstrip array antenna through the one feeding line 220. In this case, in order to supply power to the capacitive-coupled comb-line microstrip array antenna, a part of the feeding line 220, that is, an input part of the capacitive-coupled comb-line microstrip array antenna, may be directly connected to a chip or a transmission line or may be changed into transition parts having various forms. Furthermore, a matching circuit, such as a quarter wavelength transformer, may be added for impedance matching, if necessary.

As in the aforementioned embodiments, the feeding lines 220a and 220b may be configured in the form of a microstrip line. The microstrip patches 231a and 231b may be configured by changing the width (W in FIG. 2) of each microstrip patch in a way to have various pieces of characteristic impedance (G₀) in order to facilitate a design and fabrication depending on a dielectric constant (εᵣ) of the dielectric substrate 210. If a boresight pattern in which a beam direction of the capacitive-coupled comb-line microstrip array antenna is directed toward the front of the array antenna is formed, a distance d′ between the microstrip patches 231a and 231b is formed to correspond to half of a wavelength (λ_{g}/2) of the microstrip feeding line 220a, 220b so that the microstrip patches 231a and 231b, that is, radiating elements, are supplied with power in phase. If it is necessary for the capacitive-coupled comb-line microstrip array antenna to form a beam in a desired direction, a direction of the beam may be adjusted by adjusting the distance d′ between the microstrip patches 231a and 231b because a phase excited in each of the microstrip patches, that is, radiating elements, needs to be adjusted.

A comb-line microstrip array antenna having eighteen microstrip patches was manufactured according to the embodiment of FIG. 16, and performance thereof was checked. The comb-line microstrip array antenna was designed so that a vertical beam in the array direction of the comb-line microstrip array antenna had a low side lobe level and radiation conductance had a weighting distribution. As described above, the distance d′ between the radiating elements corresponds to half of a wavelength (λ_{g}/2) of the microstrip feeding line, and a gap between the feeding line and the microstrip patches is different depending on a weighting distribution. The gap between the microstrip patches and the feeding line is increased because the weighting distribution has radiation conductance that is high in the middle portion of the array and becomes lower toward both sides of the array.

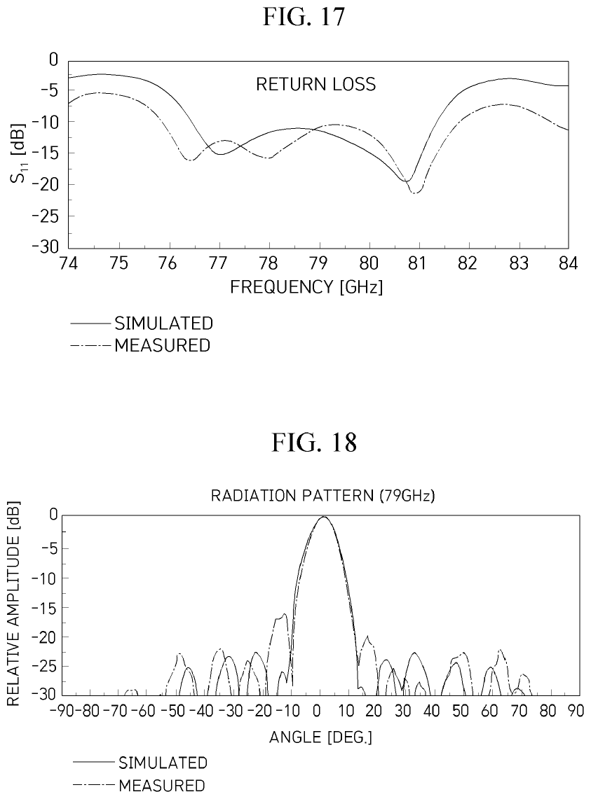

FIG. 17 illustrates reflection coefficients of the capacitive-coupled comb-line microstrip array antenna of FIG. 16. The bandwidths with −10 dB reference are 4.3 GHz (76.9 GHz to 81.2 GHz) and 4.9 GHz (81.1 GHz to 76.2 GHz) in simulated values and measured values of the reflection coefficients, respectively. The capacitive-coupled comb-line microstrip array antenna having an extended beam width according to the present embodiment (the embodiment of FIG. 16) has wide beam widths of about 33% (simulation values) and 36% (measured values) on the basis of a −5 dB beam width in the vertical plane (i.e., E-plane) compared to the capacitive-coupled comb-line microstrip array antenna according to the embodiment of FIG. 5.

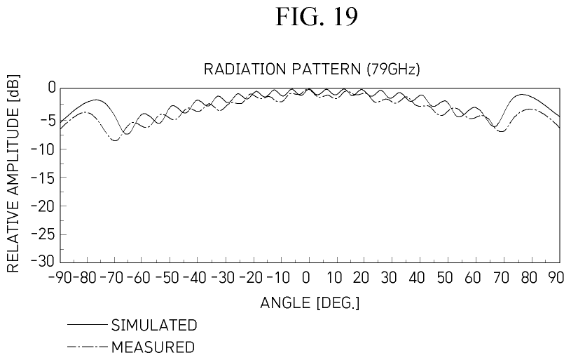

FIGS. 18 and 19 illustrate normalized radiation patterns for the vertical plane (i.e., H-plane) and the horizontal plane (i.e., E-plane), respectively, in the 79 GHz frequency band of the capacitive-coupled comb-line microstrip array antenna of FIG. 16. The −5 dB beam widths in the horizontal plane (i.e., E-plane) are 115° (−52° to 63°) and 105° (−48° to 57°) in simulated values and measured values, respectively. In the case of the capacitive-coupled comb-line microstrip array antenna of FIG. 5 having the same radiating element as those illustrated in FIGS. 12 and 13, −5 dB beam widths in the horizontal plane (i.e., E-plane) were 86° (−43° to 43°) and 77° (−39° to 38°) in simulated values and measured values, respectively. Accordingly, it can be seen that the capacitive-coupled comb-line microstrip patch array antenna according to the embodiment of FIG. 16 has wide beam widths of about 33% and 36% in the simulated values and measured values, respectively, on the basis of the −5 dB beam width in the horizontal plane (i.e., E-plane) compared to the capacitive-coupled comb-line microstrip array antenna according to the embodiment of FIG. 5.

According to the present disclosure, a small-sized array can be designed because an array structure of the microstrip patches having the same width is maintained and a distance between elements also becomes ½ compared to a conventional microstrip patch array antenna using the series-fed method due to radiation conductance determined by adjusting the gap for capacitive coupling with the feeding line, by the comb-line array of microstrip patches excited by capacitive coupling.

Furthermore, the present disclosure can solve problems in that it is difficult to design a beam having a desired side lobe level and cross polarization occurs due to thick microstrip patches in a conventional comb-line microstrip patch array antenna electrically connected to a microstrip feeding line, wherein radiation conductance is controlled by adjusting the width of the microstrip patch, that is, a radiating element, and radiation conductance of a radiating element in the middle of the microstrip feeding line needs to be greater than that of a radiating element at an edge of the microstrip feeding line in order to obtain a low side lobe level.

The antenna of the present disclosure may be used in wireless communication, a radar, etc. which require wide coverage in a millimeter band.

Although the preferred embodiments of the present disclosure have been described so far, a person having ordinary knowledge in the art to which the present disclosure pertains will appreciate that the present disclosure may be implemented in other detailed forms without departing from the technical spirit or essential characteristics of the present disclosure. Accordingly, the aforementioned embodiments should be construed as being only illustrative, but should not be construed as being restrictive from all aspects. The scope of the present disclosure is defined by the appended claims rather than by the detailed description, and all changes or modifications derived from the scope of the claims and equivalents thereto should be interpreted as being included in the technical scope of the present disclosure.

What is claimed is:

1. A capacitive-coupled comb-line microstrip array antenna comprising:
a dielectric substrate;
first and second feeding lines formed on one surface of a dielectric substrate and in parallel branched from a feeding line connected to an input port; and
microstrip patches intersected and arranged in a way to be partially overlapped within an area where the parallel first and second feeding lines are formed to face each other,
wherein the microstrip patches comprise a first group of microstrip patches formed in a direction orthogonal to the first feeding line with a gap between the microstrip patches and the first feeding line and a second group of microstrip patches formed in a direction orthogonal to the second feeding line with a gap between the microstrip patches and the second feeding line.

2. The capacitive-coupled comb-line microstrip array antenna of claim 1, wherein the gap between each of the first and second feeding lines and each of the first and second groups of microstrip patches is determined by a resonant state according to a length of each microstrip patch.

3. The capacitive-coupled comb-line microstrip array antenna of claim 1, further comprising a ground plane formed on the dielectric substrate.

4. The capacitive-coupled comb-line microstrip array antenna of claim 1, wherein the arranged microstrip patches all have an identical width.

5. The capacitive-coupled comb-line microstrip array antenna of claim 1, wherein the first and second groups of microstrip patches are arranged at intervals corresponding to half of a wavelength (λ_{g}/2) of the feeding line.

6. A method of manufacturing a capacitive-coupled comb-line microstrip array antenna, comprising:
forming, on one surface of a dielectric substrate, first and second feeding lines in parallel branched from a feeding line connected to an input port;
forming microstrip patches intersected and arranged in a way to be partially overlapped within an area where the parallel first and second feeding lines are formed to face each other,
wherein the forming of the microstrip patches comprises:
forming a first group of microstrip patches in a direction orthogonal to the first feeding line with a gap between the microstrip patches and the first feeding line, and
forming a second group of microstrip patches in a direction orthogonal to the second feeding line with a gap between the microstrip patches and the second feeding line.

7. The method of claim 6, wherein the gap between each of the first and second feeding lines and each of the first and second groups of microstrip patches is determined by a resonant state according to a length of each microstrip patch.

8. The method of claim 6, comprising additionally forming a ground plane on the dielectric substrate.

9. The method of claim 6, wherein the microstrip patches are all formed to have an identical width.

10. The method of claim 6, wherein the first and second groups of microstrip patches are formed at intervals corresponding to half of a wavelength (λ_{g}/2) of the feeding line.
